(19) United States
(12) Patent Application Publication
(10) Pub. No.: US 2024/0013195 A1
(43) Pub. Date: Jan. 11, 2024

(54) ASSET-BACKED MARKETPLACE

(71) Applicants: Third Venture Partners, Inc., Portland, OR (US); PWCC Marketplace, LLC, Tigard, OR (US)

(72) Inventors: Steven Osborn, Portland, OR (US); Brent Huigens, Tigard, OR (US)

(73) Assignees: Third Venture Partners, Inc., Portland, OR (US); PWCC Marketplace, LLC, Tigard, OR (US)

(21) Appl. No.: 18/316,679

(22) Filed: May 12, 2023

Related U.S. Application Data
(60) Provisional application No. 63/409,412, filed on Sep. 23, 2022.
(60) Provisional application No. 63/359,599, filed on Jul. 8, 2022.

(51) Int. Cl. G06Q 20/36; G06Q 20/02

(52) U.S. Cl. CPC G06Q 20/36; G06Q 20/02; G06Q 2220/00

(57) ABSTRACT

Embodiments described herein provide for systems and methods for generating blockchain tokens as tokenized versions of live assets stored in a vault. A server verifies live assets and mints vault-backed title NFTs to blockchain wallets. The server executes software (e.g., dApp; smart contract) for minting a vault-backed title NFT as UDA token corresponding one-to-one with the live asset, or optionally as a set of COA tokens, including the title NFT and a set of fungible access tokens having a subset of privileges or rights derived from the title token. The server hosts an online marketplace where users may purchase or sell the asset tokens (e.g., title NFTs or the access tokens), or may submit redemption requests for triggering or accessing privileges afforded by the asset tokens or redeeming (“unchaining”) the live assets.

### CROSS-REFERENCE TO RELATED APPLICATION

This application claims priority to U.S. Provisional Application No. 63/359,599, filed Jul. 8, 2022, which is incorporated by reference in its entirety. Further, this application claims priority to U.S. Provisional Application No. 63/409,412, filed Sep. 23, 2022, which is incorporated by reference in its entirety.

### TECHNICAL FIELD

This application generally relates to systems and methods for distributing blockchain-based non-fungible tokens and fungible tokens affording access privileges or benefits to token holders, and for managing blockchain transactions allowing users to exchange, accrue, and access the privileges or benefits of the blockchain tokens.

### BACKGROUND

Certain live assets are highly collectible and tradable, such as sports trading cards, fine art, rare gems, jewelry, vintage cards, and sneakers. These live assets can be represented by corresponding non-fungible tokens (NFTs) on a blockchain, where the NFTs include relevant information that uniquely describes and represents attributes of the live asset or include pointers to storage locations containing such information. These NFTs can be employed as a means of tracking ownership or providence of the physical assets. For instance, an NFT for an autographed baseball card could include an image of a certificate of authenticity. These kinds of valuable (and often expensive) live assets are often difficult for individuals to purchase and sell, due to the high value. A common solution is for individuals to jointly own a live asset or lease access to the physical asset.

Current approaches for blockchain-based systems, including NFT-based solutions, were not designed or intended to support joint ownership, and are often feature-poor or inefficient. This can make it challenging for communities to participate in the collective ownership of these assets. It is often difficult to understand the true value of these assets and the barriers to entry are high. The conventional approaches to NFT ownership exchange do not effectively or efficiently provide the information necessary to understand the value of the live assets or to facilitate joint ownership or joint access to reduce costs.

### SUMMARY

Embodiments described herein address the shortcomings mentioned above and may provide additional or alternative benefits as well. The embodiments include systems and methods for generating (or “minting”) fungible tokens or non-fungible tokens representing access rights to live assets (generally referred to as “access rights” or “privileges”), such as rights to gain access to a corresponding live asset, privileges to employ some functional utility of the live asset, or rights to otherwise exercise another type of interest in the corresponding live asset, where the live assets may be stored (or “vaulted”) by a blockchain platform service. The live asset may be nearly any live or digital asset that the platform service can tokenize according to access rights on the blockchain, which may include minting a vault-backed NFT (sometimes referred to herein as a “title token” or “title NFT”) that represents a title interest and may indicate comparable access rights to interact with the now-vaulted live asset. Non-limiting examples of the live asset include collectibles (e.g., art, sports memorabilia, cars), financial instruments (e.g., securities, bonds, cash), or digital collectibles (e.g., in-game assets, artwork NFTs, digitized legal instruments or wills). A person (or entity) registers an account with the platform service and vaults the live asset with the platform service. Hardware and software computing components of the platform service mint the corresponding vault-backed title token representing the owner's title interest in the vaulted live asset.

In some cases, the platform service may mint the title NFT representing the ownership or access rights of the owner of the live asset in the form of a Unique Digital Asset (“UDA”) token (“UDA token” or “UDA NFT”). A UDA-type title token uniquely represents, on a one-to-one basis, ownership or access rights to the live asset. In such cases, the platform server mints the UDA token directly to the live asset owner's blockchain wallet (or to a custodial wallet of the platform service), where the UDA token uniquely represents the access rights of the owner. Transactions and transfers involving the UDA token represent transfers for the access rights associated with the live asset reflected on the blockchain. The owner may decide to maintain a one-to-one relationship between the access rights and the title NFT, such that only the unique title token includes all access rights to the live asset. In this example, the platform server (or other computing device) of the platform service mints the title NFT as the UDA-type title token that uniquely represents the ownership rights or the access rights to the live asset, and transfers of the UDA token effectively represent a transfer of ownership access rights.

Alternatively, when minting the title token, the owner may instruct the platform server to mint a set of COA tokens representing varied access rights. The COA tokens include the initial, vault-backed title NFT representing the ownership interest and ownership access rights, which the platform server mints to the live asset owner's wallet. The COA tokens further include a set of access tokens associated with the title token and available for any number of users to acquire and hold. The access tokens represent a license or limited interest in the live asset with limited access rights. An access token may include a fungible token (or, in some cases, an NFT) on the blockchain, where the platform server mints the access token with data fields indicating (or pointing to) identifiers of the access token and the title token and a subset of access rights, among other types of data. The platform server may mint the access to the token to the wallet of the live asset's owner, to the wallet(s) of other users indicated by the inputs entered by the owner-user when minting the title token, or to the custodial wallet of the platform service.

The COA tokens offers owners of the live assets an approach to licensing, transferring, or otherwise distributing the access privileges available for the live assets. Embodiments implementing COA tokens (e.g., COA-type title token, set of access tokens) include computing processes for minting the access tokens to represent collective or distributed ownership or access privileges for the live assets, among other computing operations that leverage a decentralized blockchain network of computing devices (participating as “nodes” of the blockchain network) that manage the various tokens.

The computing processes for managing the blockchain-related functions may be performed according to software programming of a distributed blockchain application (“dApp”) or a smart contract of the blockchain, which may be executed by the platform server and/or other nodes of the blockchain network. As an example, the dApp (or smart contract) includes software programming for generating or minting the title token (e.g., UDA NFT, COA NFT) or the access tokens according to the user inputs indicating the access rights to the corresponding live asset.

In an embodiment, a method comprises minting, by the computer, a title token on a blockchain to a first blockchain wallet, the title token including a non-fungible token corresponding to a live asset and containing one or more data fields; minting, by the computer, a plurality of access tokens on the blockchain to one or more blockchain wallets, each access token includes a fungible token having a linking data field indicating the title token; updating, by the computer, a distributed table of a distributed application according to the title token and the plurality of access tokens, the distributed table containing a plurality of data fields for the title token and each access token, including an address of the first blockchain wallet and the address of each blockchain wallet having at least one access token, and a count of a number access tokens at each blockchain wallet.

In another embodiment, a system comprises a non-transitory machine-readable storage configured to store processor-executed instructions; and a computer comprising a processor coupled to the non-transitory storage. When the processor executes the instructions, the computer is configured to: mint a title token on a blockchain to a first blockchain wallet, the title token including a non-fungible token corresponding to a live asset and containing one or more data fields; mint a plurality of access tokens on the blockchain to one or more blockchain wallets, each access token includes a fungible token having a linking data field indicating the title token; and update a distributed table of a distributed application according to the title token and the plurality of access tokens, the distributed table containing a plurality of data fields for the title token and each access token, including an address of the first blockchain wallet and the address of each blockchain wallet having at least one access token, and a count of a number access tokens at each blockchain wallet.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1A shows components of a system for distributing and managing blockchain assets, according to an embodiment.

FIG. 1B is a diagram depicting a distributed table data structure used by software programming of the system for referencing token information, according to the embodiment.

FIG. 2 is a flowchart showing operational steps of a method for minting vault-backed NFTs for newly vaulted live assets, according to an embodiment.

FIG. 3 is a flowchart showing operational steps of a method for minting vault-backed NFTs for a partner company associated with a platform system, according to an embodiment.

FIG. 4 is a flowchart showing operational steps of a method for redeeming or “unchaining” a live asset according to the one or more tokens minted for the live asset, according to an embodiment.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Users with ownership rights in live assets may begin an asset transfer to a token platform service or otherwise submit information with asset transfer requests to the token platform service. The owners send the live assets to the token platform service, which stores (or “vaults”) the live assets on the user-owners' behalf. The platform service verifies the live asset and mints one or more asset tokens, including a vault-backed title NFT (sometimes referred to as a “title token”) that represents ownership access rights corresponding to the newly vaulted live asset. A platform server (or other computing device) mints the title token for the owner into the owner's blockchain wallet. In some cases, the owner optionally instructs the platform service to mint the asset tokens as a set of COA tokens, which includes the title NFT and a set of access tokens associated with the title NFT.

The platform server hosts an online marketplace where users may, for example, purchase or sell the asset tokens (e.g., vault-backed title NFTs or access tokens), or submit redemption requests for triggering or accessing consumptive rights or privileges afforded by the tokens (e.g., title tokens or access tokens), such as viewing the live asset in the vault or at a website having a digital video feed of the live asset, or redeeming the live asset to recover possession of the live asset from the platform service (sometimes referred to as “unchaining” or an “unchaining request”). Users may purchase or sell each type of token (e.g., title NFTs, access tokens) within the online marketplace hosted, managed, or otherwise controlled by the platform server of the platform service. Non-limiting examples of the rights provided by the asset tokens include rights to visit a tangible live asset at the vault or secure location (e.g., visit and photograph the live asset); rights to digitally access media data or data feed of for the live asset (e.g., access a digital, high-quality, three-dimensional virtual representation of the live asset in a virtual reality program; access a digital video feed of the live asset); rights to use a digital image of the live asset as a profile picture for a social media website or other online accounts; rights to access exclusive online community chatrooms and programs; and rights to access and attend exclusive digital or real world events (e.g., attend player interviews, attend private card signings, attend backstage events with performers).

In some embodiments, the marketplace allows users to host and sell the tokens (e.g., title NFTs, access tokens) through Web3-enabled programming. As an example, in response to a redemption request to view the live asset, the platform server may generate and present three-dimensional renderings of the live asset in a virtual environment (e.g., Metaverse, virtual reality). The user device accesses the live asset by successfully submitting a type of redemption request (e.g., viewing request, vault unlocking request), where the user's blockchain wallet holds the required type of token with the corresponding privileges to visit or view the live asset and/or the required number of tokens (e.g., threshold number of access tokens). In some implementations, the redemption requirements for a particular redemption request (e.g., unchaining request) require the title token holder to purchase (or repurchase) a predetermined threshold amount of the access tokens (e.g., 100% of access tokens), which the dApp or smart contract confirms before permitting the redemption request. For example, the smart contract determines from the configurations indicated by the data fields of the title token or access tokens that the title token holder must re-purchase 100% of the access tokens to execute an unchaining process. The node executing the dApp or smart contract (e.g., platform server) checks a data table of the dApp or executes a consensus polling process to determine that the particular user-owner's blockchain wallet includes both the title token and 100% of the access tokens.

The platform server executes software programming (e.g., decentralized dApp; smart contract of the blockchain) for minting the vault-backed title NFTs in the form of UDA-type title tokens or COA-type title tokens. The UDA title token includes a single vault-backed title NFT including data representing ownership access privileges corresponding, on a one-to-one basis, to the live asset in the vault of the platform service. The platform server (or other device) mints the UDA title token directly to the live asset owner's wallet, or to a custodial wallet of the blockchain platform service. The platform server may then make the UDA title token available for primary or secondary purchase in the marketplace website or other web-based or online application.

In some cases, the owner instructs the platform server to mint the vault-backed title NFT in the form of a COA-type title NFT and a set of access tokens. The platform server (or other device) mints the COA tokens directly to the live asset owner's wallet, or to a custodial wallet of the platform service, and then makes the title token and/or the access tokens available for primary or secondary purchase in the marketplace. The platform server may mint the set of access tokens associated with the title token as fungible blockchain tokens representing a license or limited interest, containing data representing a subset of licensed access privileges corresponding to the live asset in the vault of the platform service. Notably, in some implementations, only the holder and owners of the title token has an ownership interest in the live asset, and the users who hold the access tokens have no ownership interest in either the title token or the live asset.

The platform service provides for safe custody of the tokens on a blockchain (e.g., Polygon blockchain). The platform server may execute software programming for handling financial transactions involving the purchase or sale of the vault-backed title NFTs or access tokens, such as Know Your Customer (KYC) authorizing functions for verifying the buyers and sellers, Anti-Money Laundering (AML) functions, user authenticating functions, blockchain-bridging functions, and others. The financial transactions may ultimately settle into US dollars if the platform server (or other server) performs successful KYC and/or AML verification functions using the various types of transaction data and user data.

### EXAMPLE SYSTEM COMPONENTS

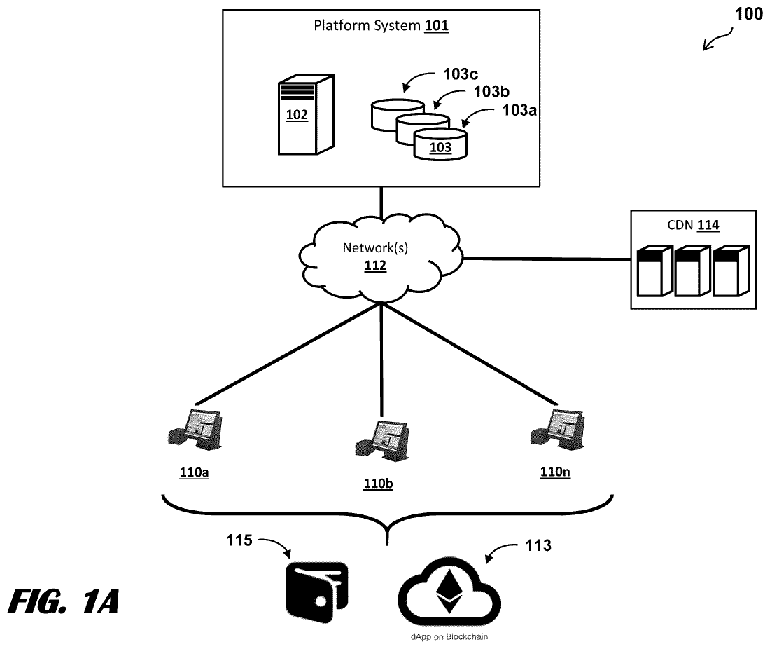

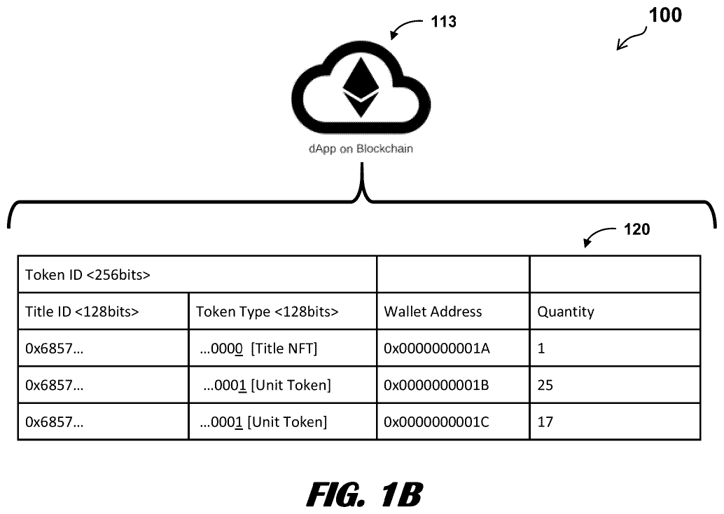

FIGS. 1A-1B depicts aspects of a system 100 for distributing and managing blockchain assets, according to an embodiment. FIG. 1A shows various computing components of the system 100 for distributing and managing blockchain assets, according to the embodiment. FIG. 1B is a diagram depicting a distributed table data structure used by software programming of the system 100, according to the embodiment. With reference to FIG. 1A, the system 100 includes a platform system 101, a content delivery network (“CDN 114”), and any number user devices 110a-110n (generally referred to as “user devices 110” or a “user device 110”), which in some circumstances, includes a seller device 110a and a buyer device 110b. The platform system 101 includes platform servers 102 and platform databases 103. The components of the system 100, including the platform system 101 (e.g., platform server 102), the CDN 114, and the user devices 110, may communicate with one another via one or more networks 112.

Embodiments may comprise additional or alternative components or omit certain components from those shown in FIG. 1A, yet still fall within the scope of this disclosure. For ease of description, FIG. 1A shows only one instance (or a small number of instances) of the various components. Embodiments, however, may comprise any number of components.

Users send live assets to a token platform service, which vaults the live assets on the users' behalf. The platform service verifies the live assets, such as physical items, collectibles, cash, or other valuables, and mints various types of vault-backed title NFTs corresponding to the vaulted live assets for the users to blockchain wallets. A platform server 102 hosts an online marketplace where users may purchase or sell the vault-backed NFTs or access tokens, or may submit redemption requests for triggering or accessing privileges afforded by the tokens or redeeming the live assets. The users may purchase or sell each type of token within the online marketplace hosted, managed, or otherwise controlled by the platform server 102 of the platform service. In some embodiments, the marketplace allows users to host and sell the tokens through Web3-enabled programming.

Blockchain and dApp

The platform server 102 executes software programming (e.g., dApp 113; smart contract of the blockchain) for minting the vault-backed title NFTs, which in some implementations, may be in the form of a UDA title NFT or a COA title NFT. The platform server mints the title token as a new NFT on the blockchain directly to the live asset owner's custodial wallet. The platform server 102 may make the title token available for primary purchase in the marketplace. The owner may instruct the platform server 102 to mint a set of access tokens associated with the title token, where the title token is the new NFT minted to the blockchain wallet of the owner or rights-holder of the live asset, and the access tokens are fungible tokens minted to one or more users' blockchain wallets or to the custodial wallet of the platform system 101, representing a subset of the access privilege rights to the live asset.

After vaulting the live asset, the platform server 102 updates one or more platform databases 103 (e.g., “asset database” of the platform databases 103), distributed table structure of the dApp 113, or other ledger data structure of live assets and asset tokens, at which point the asset tokens for the live assets are available for minting or otherwise made available in the marketplace.

The devices of the system 100 may implement and participate as nodes of a distributed computing network of the blockchain. The devices of the system 100 execute any type of open or propriety blockchain programming (e.g., Polygon®, Etherum®), which may perform various blockchain protocols for tokens, wallets, smart contracts, and dApps, among other features (e.g., ERC-20, ERC-721, ERC-1155) The blockchain entries may include any number of blocks representing various types of data of the asset tokens, including non-fungible tokens (for the title tokens) and fungible tokens (for the optional access tokens). The blockchain includes the title tokens that are NFTs containing data uniquely representing the ownership privileges of the corresponding live assets, as registered and vaulted by the platform service. The blockchain further includes the access tokens linked to the particular title token. The access tokens are fungible tokens of the blockchain representing a subset of access privileges to the particular live asset, associated with the title token representing the ownership access privileges for the live asset. The devices of the system 100 may mint or transfer the various tokens on the blockchain according to typical processes for minting interrelated blockchain tokens or transferring blockchain tokens.

Certain devices of the system 100 may access and execute software programming of the dApp 113 to execute or perform various functions on the blockchain. The dApp 113 is designed to run on a decentralized network of devices, such as the blockchain participating nodes (e.g., platform server 102, user devices 110), and provides a secure and transparent software program for users and user devices 110 to interact with the blockchain and components of the system 100. The dApp 113 includes a user interface that allows the users to access and interact with the platform system 101 functions and features, includes software programming of one or more smart contracts that govern the behavior of the devices of the system 101. The dApp 113 allows for secure and decentralized interactions between the blockchain, the platform server 102, and user devices 110. The blockchain includes the smart contract, such that the device executing the dApp 113 likewise executes the smart contract on the decentralized network (on the blockchain), ensuring that all transactions and interactions with the platform system 101 are transparent and/or tamper-proof. The dApp 113 provides a range of functions, including decentralized storage (e.g., in the CDN 114), decentralized computing, secure and transparent transactions, and access to a decentralized marketplace hosted by the platform server 102 for the buying and selling asset tokens (e.g., title tokens, access tokens).

As mentioned, the blockchain includes various smart contracts for performing various functions. The smart contract includes a self-executing software or script, sometimes representing a contract, programmed to execute automatically when a computing device executing the dApp 113 detects certain predetermined conditions indicated by programming of the smart contract. The smart contract includes machine-readable instructions that are permanently and immutably stored on the blockchain. Non-limiting examples of functions performed by the smart contracts include minting asset tokens, transferring asset tokens between wallets, and burning asset tokens, among others.

The platform server 102 may determine a number of access tokens to create based upon various values assigned to the live assets. For example, the platform server 102 determines the number of access tokens by dividing a Fair Market Value (FMV) of the live asset by $5. The live asset owner can post the COA-type title NFT and/or any number of the access tokens associated with the title NFT (e.g., anywhere from 20-100% of the access tokens), to the marketplace, making the title token or any number of the access tokens available on the primary marketplace available for purchase. At an initial sale (sometimes referred to as a “Primary Drop”) of individual tokens (e.g., title token, access tokens) in the marketplace, the live asset owner-user may initially list any number of access tokens (e.g., anywhere from 20-100% of the access tokens) of the COA in the marketplace. At the time of the initial listing, the price of each access token is, for example, $5 each. Each access token remains at the initial price until the initial supply of the access tokens is sold.

In some implementations, the platform server 102 or computing programing of the platform system 101 requires the marketplace to include listings for a minimum number of access tokens for given live asset on the marketplace. In some cases, to sell the title token, the holder of the title token must list all of the related access COA tokens. The platform server 102, for example, requires the holder of the title token to list the minimum amount of the access tokens as available; or the platform server 102 automatically lists the minimum amount of the access tokens as available on the marketplace. As an example, the platform server 102 requires the holder of the title token to list for sale on the marketplace at least 30% of the minted access tokens for the live asset at an initial listing price (e.g., $5.00 per access token). In some cases, the platform server 102 or computing programing of the platform system 101 requires the marketplace to list purchased asset tokens for resale. The platform server 102 may, for example, require the buyer of the title token to contemporaneously relist purchased asset tokens (e.g., title token, access tokens) for resale, or the platform server 102 automatically relists the purchases asset tokens (e.g., title token, access tokens) as available on the marketplace. As an example, each buyer who buys the access tokens of a given live asset must relist the access tokens on the marketplace contemporaneously to purchasing the access tokens. The platform server 102 may impose a preconfigured cap on the price of the relisted access tokens (e.g., price capped at 125% of the holder's purchase price of the access tokens). The platform server 102 may, in some cases, adjust the relisted price dynamically based on the FMV or based on an input from the holder or administrative user. Additionally or alternatively, in some implementations the platform server 102 may impose a maximum price that the marketplace may accept for an auction (e.g., auction price of the access token cannot be more than $10.00).

In some implementations, the platform server 102 executes certain programming for performing special handling operations (e.g., particular KYC verifications) when selling or transferring the title token between a buyer and a seller. In some implementations, the holder of the title token has the right to reserve all or none of the access tokens held in the holder's wallet. The reserved access tokens include unlisted access tokens, where the platform server 102 does not list the reserve access tokens in the marketplace with the particular price. The platform server 102 may display the reserve access tokens, though the platform server 102 does not list the reserve access tokens. The holder of the title token may earn a certain amount of sales of the access tokens on the marketplace, either at the initial listing or at secondary sales at a later transaction.

The platform server 102 may mint the title token at the time of the primary drop, in addition to minting or creating the rest of the access tokens associated with the title token representing the live asset. The platform server 102 may mint the title token in the original asset owner's blockchain wallet. The marketplace does not list the access tokens at the primary drop, and may remain hidden in the owner's wallet until a smart contract detects a preconfigured triggering condition is satisfied (e.g., a percentage of access tokens are sold), or until such time that the initial owner chooses to sell the access tokens in the marketplace. In some cases, the access tokens are not available for purchase or takeover as long as the title token remains with the current asset owner.

Networks and Computing Infrastructures

The system 100 of FIG. 1A comprises various network infrastructures 101, 114 including the platform system 101 and the CDN 114. Each network infrastructure 101, 114 includes a physically and/or logically related collection of devices owned or managed by a certain enterprise organization, where the devices of each infrastructure 101, 114 are configured to provide the intended services of the particular infrastructure 101, 114 and responsible organization.

The system 100 includes any number of networks 112, which may include external or public networks (e.g., Internet) and/or private networks (e.g., virtual private network (VPN), intranet) for internal communications within the computing infrastructures 101, 114. The networks 112 comprise various hardware and software components for hosting and conducting data communications between the various devices of the system 100. The devices of the platform system 101 or the CDN 114 may communicate internally (within the respective logical or physical infrastructure 101, 114 of the platform system 101 or CDN 114) via one or more internal networks. For communicating beyond the logical or physical infrastructures 101, 114, the devices of the system 100 may communicate via any number of external networks 112. The various computing networks 112 of the system 100 comprise hardware and software components defining the one or more public networks or private networks, interconnecting the various components of the system 100. Non-limiting examples of the computing networks may include Local Area Network (LAN), Wireless Local Area Network (WLAN), Metropolitan Area Network (MAN), Wide Area Network (WAN), and the Internet. Computing devices of the system 100 communicate via the various computing networks in accordance with various communication protocols, such as Transmission Control Protocol and Internet Protocol (TCP/IP), User Datagram Protocol (UDP), and IEEE communication protocols, and the like.

Content Delivery Network

The CDN 114 includes any number of computing devices configured to host, store, and update various types of data. The CDN 114 includes a plurality of servers strategically located at various geographic locations to deliver content to the user devices 110 (or other devices of the system 100) efficiently. The CDN 114 includes a central CDN server that receives user requests for content and identifies the location of the user device 110. Based on the location of the user device 110, the central CDN server selects a closest CDN server and routes the content to that closest CDN server for delivery to the user device 110. The CDN servers are equipped with caching capabilities to store frequently accessed content, reducing the overall load on the various servers of the CDN 114, improving the speed and reliability of content delivery.

In some implementations, the CDN 114 functions as a distributed non-transitory storage medium. The CDN 114 stores various types of information related to the asset tokens or for providing particular functions or features of the asset tokens. For instance, the CDN 114 may function as a media store for storing and distributing media files associated with the live asset or asset tokens associated with the live asset.

Platform System, Platform Server, and Platform Database(s)

A token platform service is an entity that manages and operates the platform system 101. The platform system 101 comprises various hardware and software components for hosting and managing the various features and functions described herein. The platform system includes a platform server 102 and a platform database 103.

The platform server 102 includes hardware and software components capable of performing the various processes and functions described herein. The platform server 102 may function as a touchpoint between the user devices 110 and the platform system 101, which includes performing processes for authenticating users, hosting a marketplace webpage, and managing various blockchain-related functions, among other functions. The platform server 102 may perform various operations in response to instructions received from the user devices 110 or smart contracts of the blockchain, such as new token requests, sell orders, or buy orders, among others.

The platform server 102 executes software programming of a webserver (e.g., Microsoft IIS®, Apache HTTP Server®) for hosting the marketplace website and executing programming of a web-based software application (“web app”). The platform server 102 receives user inputs from a browser of the user device 110 that instructs the platform server 102 retrieve and display various types of information related to the marketplace webpages and the asset tokens. The platform server 102 presents, for example, a webpage listing an asset token for sale in response user inputs indicating the user would like to offer the asset token for sale through the marketplace.

The platform server 102 may register users and user devices 110 with the platform system 101. This may include storing or updating various user account information in the platform database 103. The user information may include authenticating information for identifying and authorizing the user and user device 110. In operation, the platform server 102, the dApp 113, and/or a smart contract on the blockchain, executes an authentication operation by comparing the authenticating information in the database 103 against purportedly authenticating information (e.g., asserted credentials) received from the user device 110 during the authentication operation.

The platform server 102 performs processes for ingesting live asset information associated with a title-holding user after the live asset is stored (or “vaulted”) in a secured storage vault. The platform server 102 may receive a new token request from the user device 110 of the titled user who owns the live asset and execute the smart contract for minting the title token for the live asset. For instance, the platform server 102 includes a software program (e.g., a blockchain application; an instance of the dApp 113) containing executable instructions for interacting with the blockchain and initiating the execution of the smart contract. The smart contract includes instructions that govern the creation of the new asset tokens (e.g., title token and access tokens), including the specific characteristics and properties of the asset tokens. The platform server 102 server communicates with the blockchain through the network 112 to initiate the transaction, and mints the new title token to a designated address of a blockchain wallet 115 accessible to the user device 110 of the title holder. In addition, the platform server 102 mints a set of access tokens to any number of blockchain wallets 115 accessible to the user devices 110 of the users having blockchain wallets holding the access tokens. The smart contract may mint the asset tokens (e.g., title token and access tokens) to the blockchain as a public ledger indicating transaction records of the transfer or generating of the asset tokens to the addresses of the particular wallets 115.

The data fields of the various types of tokens minted by the platform system 101, including the UDA-type NFT and COA-type NFT (title token), includes the set of privileges (sometimes referred to as “licensing rights” or “licenses”) available to the holder of the title token (or the access tokens). The holder may be the owner of the live asset or temporarily holds the title token according to a leasing smart contract that temporarily transfers the title token to the wallet 115 of the temporary holder. In some cases, when minting the access tokens derived from the title token, the access tokens may receive the same privileges or a subset of the privileges of the title token, as granted by the title owner according to the configuration inputs entered with the new token request. The access tokens are fungible tokens tied to the title token including data fields representing on the public ledger blockchain, for example, the subset of permissions available to the holder of the access token and a unique identifier of the title token.

The access tokens may receive the same privileges or a subset of the privileges of the title token, as granted by the title owner according to the configuration inputs entered with the asset transfer request or similar new token request. In some configurations, the live asset and the title token have a one-to-one relationship, such that only one set of permissions are minted to the title token for the live asset. In some configurations, the live asset has a one-to-many relationship with the asset tokens, such that smart contract mints the title token and the set of access tokens, where the privileges of the title token and the access tokens are near-identical or essentially the same. In some configurations, the privileges for the live asset are assigned to the asset tokens as a hierarchical tree structure, such that the privileges of the title token may be divided into a smaller set of licensed rights in the access tokens. In some cases, the license rights of the access tokens may be further sub-divided into sublicenses in sub-level (hierarchically lower) access tokens.

With reference to FIG. 1B, a diagram shows a distributed table data structure (“distributed table 120”) within, or accessed by, the programming of the dApp 113, as executed by one or more devices of the system 100. As mentioned, the asset tokens may include data fields containing information describing, for example, the live asset, the particular asset token (e.g., unique identifier, hash), the associated tokens (e.g., unique identifier of title token), and the privileges for functional utility afforded to the holder of the particular asset token, among other types of information. The smart contract for minting the asset tokens records one or more of these data fields publicly or generates a publicly available transaction block containing these data fields.

The dApp 113 on the blockchain contains data structures (e.g., distributed table 120) for the asset tokens or pointers to non-transitory storage locations (e.g., databases 103, CDN 114) containing such data structures. The dApp 113 may further includes access controls, the distributed table 120, and instructions for the platform server 102 or user devices 110 to access or modify the distributed table 120.

As shown in the distributed table 120, the asset tokens are represented by a set of data fields, such as a title identifier (Title ID), a token type (Token Type), wallet address, and quantity of the tokens at the wallet address. For a given asset token (e.g., the title token; the particular access token), the distributed table 120 may include a Token ID based on, for example, encoding both the Title ID (128-bits) and the Token Type (128-bits) into the single Token ID value (256-bits) in the distributed table 120. The distributed table 120 may be organized or indexed according to the respective Token ID and Wallet Addresses of the wallets for the token holders. In some cases, the distributed table 120 includes a quantity data field representing a number of access tokens of a particular Token ID possessed by a particular wallet address.

Turning back to FIG. 1A, the devices of the system 100, the blockchain entries, or a remote storage location (e.g., CDN 114) may store additional types of asset data (e.g., user-entered data, metadata) about a particular asset token associated with a particular token identifier (Token ID). As an example, the dApp 113 may reference the Token ID of the asset token to retrieve a preconfigured uniform resource identifier (URI) that functions as an address or pointer (stored in the database 103, blockchain block, distributed table, or other non-transitory storage) to a particular computing resource (e.g., remote storage location, blockchain address, web address). For instance, the browser or other software application of the platform server 102 or user device 110 accesses the additional data of the asset token via the network 112 (e.g., Internet) using the URI provided by the dApp 113. In operation, the dApp 113 may determine, retrieve and return, or otherwise resolve the URI for the particular asset token. For instance, the dApp 113 accesses the URI via the network 112 to request the data contained at the given URI, which may a CDN 114 storage location, database 103, or other storage location. The data at the URI includes one or more computer-readable files containing the metadata associated with the asset token. In some implementations, for example, the data at the URI includes a JSON object containing the asset data and one or more hyperlinks (or other types of pointers) to other relevant files (e.g., media files, documents) in the same or different storage location.

This asset data may include various types of data, including computer files, user-entered data received with configuration inputs of the new token request, or various forms of metadata. Non-limiting examples of the asset data includes: hyperlinks (or other types of pointers) referencing media data (e.g., image files of the live asset); a text-based description of the live asset; a key-value pair representing various attributes of the live asset (e.g., a key field for the asset token's creation date and a value field for the date stamp in the form [YYYY-MM-DD]); an optional title token transfer fee; an optional access token transfer fee; links or pointers to a text file containing holder agreements or terms of service for the live asset; and links or pointers to text files containing descriptions of the token holder's privileges or benefits); among various other types of asset data.

With respect to the marketplace hosted by webserver of the platform server 102, the web app of the marketplace website allows the users and user devices 110 to perform various types of transactions involving the asset tokens, such as buying, selling, trading, and “unchaining” the title token and/or access tokens. The marketplace website includes or references programming instructions of an application programmable interface (API) and an instance of the dApp 113 (or similar blockchain application).

The API contains includes instructions executed by the platform server 102 and/or the user devices 110 for exchanging certain types of data related to the transaction. The API may further include the instructions for performing for the transactions (e.g., transferring, buying, selling, trading, and unchaining). The API includes instructions for the platform server 102 user devices 110 to communicate with multiple data stores (e.g., databases 103, CDN 114) to provide the user devices 110 relevant transaction information for generating a user interface. The software of the user device 110 (e.g., local blockchain app, browser, dApp 113) renders the user interface for display to the user, which may include displaying results of automated actions or prompts for the user to enter certain inputs.

As an example, the platform server 102 executes the dApp 113 to retrieve asset data from the URI of a remote storage location in the CDN 114. The dApp 113 returns the JSON object containing the various types of asset data. The platform then executes the API to format and provide portions of the asset data to the user device 110, which renders the formatted asset data on the user interface of the user device 110.

In some embodiments, the platform server 102 (or other component of the system) executes software for a blockchain bridge that allows for the transfer of asset tokens and data between different blockchains. The blockchain bridge includes a set of software protocols and algorithms that enable the seamless transfer of asset tokens and data between two or more blockchains, regardless of the underlying protocols or architectures. In some implementations, the blockchain bridge instantiates a set of proxy tokens on a target blockchain that represent the asset tokens or data being transferred from a source blockchain. In some cases, these proxy tokens may be redeemed for the original asset tokens, assets, or data on the source blockchain, allowing for the transfer to be completed. In some cases, the source tokens or proxy tokens are burned by transferring the source tokens or proxy tokens to an address of an invalid or inaccessible “dead” wallet.

In some cases, the blockchain bridge queries a current state of the live asset or the asset token in the dApp 113. The blockchain bridge may perform the query in response to a request that the platform server 102 receives from a user devices 110, or in response to automated requested from the dApp 113 or other device of the system 100 when executing certain transactional operations.

The platform system 101 includes one or more platform databases 103, such as a user profile database (sometimes referred to as an “account database 103b”), asset database 103b, marketplace transaction database (or order book database), media databases, or other types of databases. The platform database 103 may be hosted by any computing device having computing hardware (e.g., processors, non-transitory machine-readable memory) and software capable of hosting the information and executing queries received from components of the system 100, which may include queries submitted from the platform server 102, user devices 110, or the dApp 113. The data stored by the platform database 103 may include, for example, user profile data, asset data, user device data, and asset token data, among other types of data, though some or all of the data may be stored in the asset tokens or the dApp 113, or as other entries of the blockchain. In some embodiments, the platform database 103 includes a simple text file listing of information, such as a text file containing a listing of asset data. In some embodiments, the platform database 103 is hosted in a distributed computing system implementing a sophisticated database architecture. For example, the platform system 103 includes several computing devices hosting the platform database 103, which implements a relational database architecture and management software. Additionally or alternatively, in some embodiments, the computing devices of the CDN 114 store at least a portion of the platform database 103 in a remote storage. As an example, the CDN 114 may store larger media files associated with asset tokens, such as images of the live assets represented by the title token.

The dApp 113 or other programming of the system may poll or respond to polling for confirming blockchain transactions. As an example when a user intends to sell or buy one or more tokens, the seller operates the dApp 113 to submit a sell or buy transaction request or sell order or buy order, indicating the tokens associated with the transaction. A smart contact prompts the user for approval at the user interface and may post an approval request to the blockchain, which generates and returns a transaction identifier. The smart contract or other component of the system 100 may generate the sell order and transaction identifier on the blockchain and/or in the database 103 corresponding to a pointer added to the blockchain. The dApp 113 or platform server 102 polls participating nodes of the blockchain for consensus approval that the data of the transaction is accurate and permitted, and the transaction may proceed. In some cases, the transaction proceeds and the tokens are transferred between wallets. In some cases, however, the platform server 102, dApp 113, or smart contract updates the database 103 to include a new order record (e.g., buy order, sell order), and the transaction awaits until the platform server 102 or dApp 113 identifies a corresponding order (e.g., sell order, buy order) satisfying the parameters (e.g., pricing, timing) of the pending order.

The user profile database 103a includes user profile data includes information about the users registered with the platform service. Non-limiting examples of the use data includes user information, user authenticating data (e.g., login credentials), user device identifiers, addresses for user-registered wallets 115, asset tokens held in the user wallet 115, and user-registered live assets, among other types of user-related information.

In some cases, the marketplace allows users to establish profile pages that serve as a social network, where the profile page include information about the user and the user's asset tokens in the user's wallet 115. In some cases, the profile page may serve as the user's sales outlet listing the user's asset tokens and live assets available for purchase or up for auction through the user's profile page. The platform server 102 may populate the profile pages based on, for example, the user's data stored in the user profile database 103a or the user's relevant asset token data in the asset database 103b.

The platform databases 103 may include an asset database 103b that includes the various types of asset data. The asset database 103b includes, for example, a listing or data records of the asset tokens in circulation in the platform system 100 or available via the marketplace. The asset data includes, for example, the live asset identifiers, asset token identifiers, and links or pointers to other storage locations (e.g., blockchain entries, dApp 113, CDN 114) containing asset-related data (e.g., media data), among other types of asset data.

In some implementations, the asset database 103b tracks the entire lifecycle of events associated with a given asset token, as shown in TABLE 1 below.

TABLE 1

| Event | Description |
|---|---|
| created | newly added asset transferred by a partner to Jump |
| minted | Token was created to represent the asset |
| listed | assets listed on the marketplace |
| transferred | Asset was purchased |
| redeemed | Assets that have been removed from the blockchain (burned) |

In some embodiments, the asset tokens may contain properties (sometimes referred to as “traits”). These properties may be referenced by the various processes for updating the marketplace or displaying images of the live token at the user device. The platform server 102 or other programming may reference data fields or tags associated with the asset record or asset token record to identify similar live assets or asset tokens to those asset tokens in the user's wallet or to create groups or collections of similar asset tokens. For instance, the marketplace may allow a token holder to create a category or bundled collection of similar asset tokens for similar live assets, and present the category or bundled collection of asset tokens on the marketplace.

In some embodiments, the database 103 includes an order book containing information about proposed orders, representing various types of non-immediate or delayed transactions for digital assets between users. The users may enter various types of information about the proposed orders into the user interface of the blockchain application, instructing the platform server 102 to generate or update a data record for the order (“ORDER” or “ORDER record”) in the order book. The ORDER may represent, for example, a buy order or sell order and includes various types of data about the proposed order. Example types of data in a transaction record or order record are shown in TABLE 2 below.

TABLE 2

| Field Name | Description |
|---|---|
| type | type of order (e.g., buy, sell) |
| maker | Order creator |
| taker | User acting on order |
| date_created | Date order was placed |
| date_expires | Date a buy order expires or auction closes. |
| | (e.g., 1 day; 1 month in the future) |
| date_closed | Date order was accepted, rejected, canceled, expired |
| status | (pending, open, accepted, rejected, canceled, |
| | filled, expired) |
| assetId | Asset order is issued for |
| requested_qty | quantity requested for asset |
| remaining_qty | Unfilled quantity. Initially, this should be |
| | equal to the requested quantity. |
| pay_token | Payment token maker wishes to transact with |
| token_price | Payment amount maker wishes to offer/ask for |
| | the entire order. |

The ORDER record may correspond to or invoke a given smart contract for transferring digital assets on the blockchain. The data fields in the ORDER record include execution parameters or instructions for the smart contract. Non-limiting examples of the data fields of a given ORDER record includes account identifiers for users or user devices, price (e.g., listing price, bid price, ask price), permission information, and block identifiers for the relevant tokens on the blockchain, among other types of information. When executing the proposed order, the platform server 102 or user device 110 executes the corresponding smart contract, where the smart contract references the data fields of the ORDER record as various preconfigured parameters.

The platform server 102 may update a status identifier in the ORDER record, such as “open,” “available,” “closed,” or “filled” (or similar status indicator). Examples of the order status are shown in TABLE 3 below.

TABLE 3

| Status | Description |
|---|---|
| pending | Sales order has been created pending asset transfer. |
| | Once the transfer has been completed status |
| | can be updated to “open” |
| open | The order is active and awaiting a match |
| accepted | A buy order was accepted |
| rejected | A buy order was rejected |
| filled | An order was filled |
| canceled | Order was canceled by maker |
| expired | Order expired |

The platform server 102 receives an input for a new sell order from the seller device 110a for a digital asset (e.g., token, COA unit), and updates the order book to indicate the status of the given order, which the platform server 102 may initially set as “open” or “pending” status (or similar status indicator), indicating the digital asset is available for purchase on the marketplace website or the order is under some formal review. The platform server 102 generates the ORDER record in the order book, but does not create a transaction in the blockchain or other transaction log memory (e.g., database 103).

For some transactions in the order book, the platform server 102 (or other device of the system 100) performs the given transaction by comparing and matching buy against sell orders between listed in the marketplace website by two users. When a user lists a digital asset for sale, the platform server 102 generates and stores an ORDER record indicating the user's intent to sell the asset in the order book as a “SELL ORDER” database record in in the order book database 103c. The platform server 102, however, does not create a transaction. A buyer-user may review the information of the SELL ORDER on the marketplace website, such as the listing price. The buyer-user may accept the listing price and proceed with the transaction by entering a corresponding purchase input at the user interface, prompting the platform server 102 to generate the ORDER record indicating the buyer's intent to purchase the digital asset in the form of a “BUY ORDER.” In some implementations, the buyer may enter an authorizing inputs (e.g., electronic signature) indicating the buyer's agreement, and counter-order, to the SELL ORDER. The platform server 102 may stores the authorizing input into the BUY ORDER, and matches the data fields of the BUY ORDER against the corresponding data fields of the corresponding SELL ORDER for the given digital asset.

In some embodiments, the ORDER record in the order book 103b includes data fields indicating which party initiated the transaction as a first mover (“maker”) and which party accepted the transaction (“taker”), sometimes referred as a “MAKER field” and “TAKER field” in the ORDER record. The MAKER field indicates the first-mover of the transaction, where the maker includes the user or user device 110 that indicated either intent to sell a digital asset (as the maker-seller) or intent to purchase by bidding on the digital asset (as the maker-buyer). The taker includes the responding user or user device 110 that submitted a response to the maker's order on the marketplace website by either buying the digital asset (as the taker-purchaser) or accepting a bid on the digital asset (as the taker-seller).

The marketplace website configures the ORDER record as public or private, according to the configuration inputs received from the user device 110 of the user that generated the ORDER record. The mover-user may establish permissions to access the proposed transaction by entering configuration inputs indicating a specified taker-user in the TAKER field of the ORDER record. When the blockchain application, executed by the platform server 102 or the user device 110, invokes the smart contract for the proposed order, the smart contract determines whether the specified user or user device 110 in the TAKER field matches the captured identifying information of the current user or user device 110 attempting to access the proposed order or trigger the proposed transaction.

As an example, the sell order is publicly available on the marketplace website when the maker-seller does not specify a particular taker-buyer. In this example, the data fields of the SELL ORDER are publicly accessible when the TAKER field is NULL, allowing any user or user device 110 to accept (or take) the proposed order transaction of the ORDER record.

As another example, the mover-seller configures the proposed order as private by specifying a particular taker-buyer, thereby limiting access to the proposed order information and/or limiting permission to accept the proposed order according to the specified taker-buyer. In this example, the TAKER field of the SELL ORDER indicating the particular identifying information of the specified taker-buyer(s). The website restricts access to the data fields of the SELL ORDER and/or restricts permissions to accept the proposed order to only the users or user devices 110 having the identifying information in the TAKER field. In this way, the smart contract performs the transaction only in response to confirming that the taker's identifying information matches specified identifying information in the TAKER field. No other account information can successfully invoke and execute the smart contract to transfer ownership over the digital asset.

In some embodiments, the order book includes data records particular types of buy orders, including bids and offers. The platform server 102 determines whether a given buy order is a bid order or offer order, based upon the taker indicated by the order record. An offer is unsolicited. Any owner of an asset with an offer can accept the offer, even if the current owner was not the asset's owner at the time the offer was made. For offer orders, the BUY ORDER record contains a NULL value (e.g., no address or identifying information) for the TAKER field. For bid offers, the BUY ORDER record contains data indicating any buyer in the TAKER field. A bid, in contrast, is made in response to the creation of an auction. Bids are personal to an auction's creator and are eligible to be automatically matched with the auction's original sell order at the end of the auction. The creator of an auction may choose to accept a bid or offer before the auction ends.

It should be appreciated that these optional marketplace listing-types mentioned herein are merely examples and not limiting on the potential arrangements of the transactions available through the marketplace. In operation, various components of the system 100 (e.g., dApp 113, platform server 102, user device 110) may execute software programming of the blockchain transactions for transferring the tokens from one wallet 115 to another wallet 115.

User Devices

The user device 110 includes any computing device having computing hardware (e.g., processors, non-transitory memory) and software for performing the various processes and tasks described herein. Non-limiting examples of the user device 110 include servers, desktops, laptops, mobile devices (e.g., smartphones), tablets, and the like. In some cases, the user devices 110 participate as nodes of the blockchain and execute the blockchain application, which may include the dApp 113, a browser accessing blockchain functions of the web app of the platform server 102, or a browser extension performing the blockchain functions on the client-side of the browser session with the webserver of the platform server 102, among other potential configurations of the blockchain application.

When executing the blockchain application (e.g., dApp 113, browser in communication with the web app), the user device 110 exchanges various types of inputs and outputs with the platform server 102 or other devices of the system 100 according to the commands and configuration inputs entered by the user via the user interface presented on the user device 110. The user device 110 may receive data from the platform server 102 via the API, which formats the data returned from the platform server 102 for rendering on the user interface in the blockchain application, which includes a desktop or mobile application or browser. The data rendered on the user interface may include, for example, the live asset data, the asset token data, privileges (or “licenses”) information, or media data associated with the asset token. The user interface of the blockchain application allows the user to interact with the services of the platform server 102 or dApp 113, where the user enters, for example, commands or configuration inputs for submitting functional transaction requests (e.g., buying, selling, trading, unchaining) or data updates using various user interface elements (e.g., buttons, form fields). The API of the platform server 102 ingests and formats the user inputs from the user interface

The asset holder of a given live asset operates the user device 110 perform an “asset transfer process,” in which the asset holder instructs the platform service to convert the live asset into asset tokens on the blockchain. Technologically, the user enters commands for a new token request into the user interface blockchain software (e.g., dApp 113) executed by the user device 110. The new token request includes instructions for the platform system 101 to execute the smart contract and other processes for minting the new asset tokens. The new token request also includes various parameters that correspond to, or derive from, the user's configuration inputs, received from the user when submitting the new token request at the user interface. Non-limiting examples of the user configuration inputs for the asset transfer process include an indication of one or more types of asset token to mint (e.g., UDA tokens; COA tokens), a number of access tokens to mint, and an indication of a set of one or more privileges (or license rights) afforded to the asset tokens, among others. The blockchain software of the user device 110 sends the new token request to the platform system 101, prompting the platform server 102 (or other component of the platform system 101) to generate the new asset tokens (e.g., title NFTs, access tokens) corresponding to the live asset belonging to the asset holder.

The blockchain software executed by the user device 110 may trigger the platform system 101 to perform various other functions or transactions. For instance, the blockchain software allows the titled user or licensed user of to redeem an asset token from the marketplace website. For UDA title tokens, the titled user holds the sole asset token in the user's wallet 115. The user device 110 transmits a redemption request to the platform server 102, which executes programming (e.g., web app, smart contract, dApp 113) for authenticating the user and confirms that a requested privilege included in the redemption request matches to the privilege indicated in the title token or in the database 103. In some cases, if the platform server 102 proceeds with the requested redemption process, such as an unchaining process, then a smart contract may burn the title token by, for example, transferring the title token from the user's wallet 115 to the address of an inaccessible or invalid blockchain wallet.

For COA tokens, the owner holds the COA title token in the owner's wallet 115 and one or more licensed users may hold the access tokens in the respective user wallets 115. If any wallet 115 or user device 110 holding any of the COA tokens (e.g., title token, access tokens) submits a redemption request to the platform server 102, then the platform server 102 (or component of the system 100) authenticates the user and confirms that the user's wallet 115 holds sufficient COA tokens for performing the redemption process. For instance, when initially minting the COA tokens, a configuration parameter received from the owner may indicate a quorum threshold number of access tokens required to perform certain redemption processes (e.g., access the functional utility benefits; view or visit the live asset; recover and repossess the live asset). As an example, the platform server 102 must determine that the wallet 115 of the user attempting to take possession of (or redeem) the live asset holds the title token and all, or two-thirds, of the access tokens before performing an unchaining process for recovering or repossessing the live asset from the vault.

As another example, a company seeking to draw attention to a product release vaults a live asset (e.g., contest prize) with the platform service. The platform server 102 or user device 110 executes a smart contract that detects when the user performs a certain action (e.g., the user device 110 detected in a geolocation fence) and, in response, mints or transfers an access token to the user's wallet 115. The privileges of the access tokens instruct the platform server 102 to allow users to access privileges for attending an event or community forum for users interested in the product. Another smart contract on the blockchain detects when a particular winning user collects the preconfigured quorum of access tokens in the user's wallet 115. The smart contract transfers the title token for the contest prize (live asset) from a custodial wallet 115 of the platform service or the company to the wallet 115 of the winning user. The smart contract submits the redemption request to the platform server 102 instructing the platform server 102 to perform the redemption process for unchaining and repossessing the content prize to give the content prize to the winning user. The platform server 102 may confirm that the user device 110 of the user submitted the address of the winner's wallet 115 having the title token and the quorum number of access tokens.

The user may operate the blockchain application of the user device 110 to create a sale order or buy order on the marketplace website hosted by the platform server 102. The browser of the user device 110 requests the webpages of the marketplace for presenting the listing of sale offers or purchase offers on the marketplace and for presenting details about the particular asset tokens listed in the marketplace. In some cases, the titled user (e.g., holding the title token or UDA token) or licensed users (e.g., holding access tokens; holding temporarily licensed title token or UDA token) may operate the blockchain application of the user device 110 to resell or sublicense the asset tokens or rights in the asset tokens via the marketplace website, where the transaction may trigger a smart contract that transfers the particular toke from a wallet 115 to another wallet 115.

### Example Processes

Asset Transfer and Redemption Process

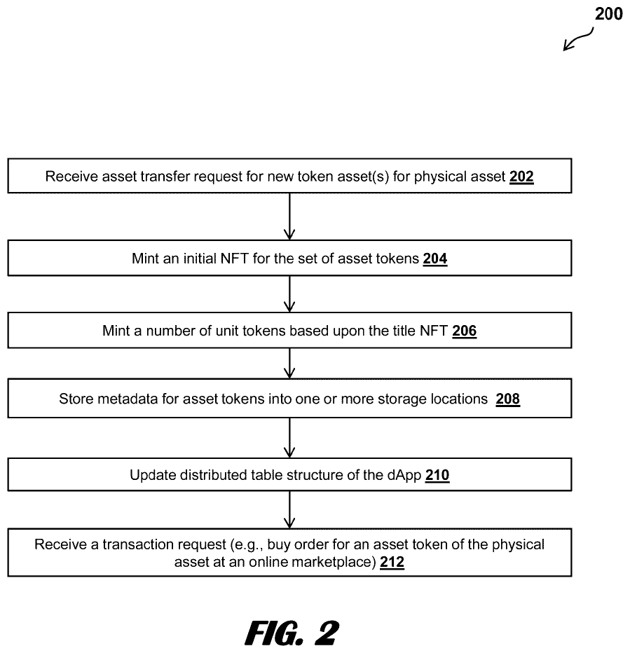

FIG. 2 is a flowchart showing operations of a method 200 for minting new title NFTs for newly vaulted live assets. The tokens may include UDA-type title NFTs or COA-type title NFTs. An owner-user may send a live asset to a platform service for storage and for generating asset tokens, which includes the title NFT and, in some cases, one or more access tokens associated with the title NFT. Contemporaneously, a server of the platform service (or other computing device) begins executing software programming for performing the operations of the method 200.

In operation 202, the server receives an asset transfer request from a user device for minting one or more new asset tokens associated with the live asset. The asset transfer request includes instructions for the platform server to invoke the smart contract for minting the new asset tokens. The smart contract may mint the new asset tokens according to one or more parameters, such as a type of token to mint (e.g., title NFT, access tokens) or the address of the target wallets, among others. In some cases, the user enters configuration inputs that expressly indicate these parameters. Additionally or alternatively, these parameters map to various types of data that the user enters as the live asset information or the asset tokens. The asset transfer request may likewise include various types of data, such as live asset data or asset token data, which map to potential types of parameters of the smart contract for minting the new asset tokens. The server receives the asset transfer request that includes the instructions for invoking the smart contract and further includes the types of data that map to parameters used by the smart contract when minting the new asset tokens.

The asset transfer request indicates a type of initial or title token to represent the live asset, where the type of title token could be a UDA NFT or a COA NFT. In some cases, the asset transfer request or other instruction from the owner may further indicate the owner would like the platform service to mint a number of access tokens associated with the title token. The asset transfer request may further indicate the one or more privileges available to users holding the title token or the access tokens, where the privileges may include (digital or real world) access rights to the live asset, or (digital or real world) access rights to a community forum of users, among others.

In some implementations, the platform server may automatically invoke the smart contract for the asset transfer method 200 in response to receiving a notification that the new asset data for the new live asset was vaulted and registered with the platform database. The platform database (or other device of the platform system) may, for example, receive user inputs from the owner or an administrative user of the platform service indicating that the live asset was successfully vaulted and the asset database records include the relevant information related to the live asset.

In operation 204, the platform server executes the smart contract that mints the new title token representing the ownership rights corresponding to live asset. Optionally, in operation 206, the smart contract further mints one or more access tokens including data fields linking the access tokens the title token.

The asset transfer request may include data indicating the addresses of the destination blockchain wallets. The smart contract takes the addresses as parameters for minting the new asset tokens to the indicated wallet addresses. In some cases, the smart contract mints the new tokens directly to a particular wallet. For instance, the smart contract mints the title token (as in operation 204) directly to the wallet of the titled-owner registered with the platform system, as indicated by, for example, a user profile database record. In some cases, the smart contract mints some or all of the tokens to a central custody wallet for subsequent distribution or transfer. For instance, the smart contract mints the access tokens (as in operation 206) to the central custody wallet until users buy or otherwise acquire the access tokens or directly to the wallets of the license-holder owners.

In operation 208, the platform server stored various types of data for the asset tokens or live asset to one or more storage locations. As an example, the platform server stores values of certain data fields into a platform database or ledger storage location. As another example, the platform server stores media data (e.g., image file) of the live asset into the platform database or into one or more devices of a CDN or other storage location.

In operation 210, the platform server (or other computing device executing a dApp or smart contract) may update a distributed table structure containing various types of asset token data. The distributed table may be encoded within the dApp and/or the dApp may include pointers to a storage location containing the distributed table or entries of the distributed table. The distributed table includes identifying information for the asset tokens, including token identifiers for the given token, and wallet addresses. The distributed table may further include an indicator of the number of access tokens held by each wallet. The data values in the distributed table are referenced by the dApp, smart contracts, or computing devices when performing various operations. For example, when the platform server receives a redemption request for a given privilege, the platform server may reference the distributed table to determine whether the user wallet holds a sufficient number of access tokens and/or the title token to satisfy a quorum threshold for the redemption request.

In operation 210, the platform server receives a transaction request from the user device containing instructions to execute one or more transactions, such as buying, selling, trading, redeeming, or otherwise transferring asset tokens. The dApp, as executed by the platform server or the user device, triggers transfers from a first user's wallet (e.g., seller's wallet) to a second user's wallet (e.g., buyer's wallet). When performing the requested transaction operations, the platform server executes API programming for communicating various instructions or transaction-related data with the dApp. The dApp (or a smart contract) executes the programming functions for transferring a particular asset token according to the token identifiers in the distributed table.

The dApp includes the distributed table or other data structure indicating the token identifiers, URIs associated with the token identifiers, among other types of data. The user device or dApp queries the token identifier of the asset token of the transaction for the URIs (e.g., blockchain address, storage locations, platform database records), and forwards the token identifier and URIs to the platform server. In response, the platform server uses the URI(s) to fetch the asset token data from, for example, the blockchain address, the platform database, or a storage location of a CDN. In some cases, the platform server may update the display of the user interface using the information retrieved according to the URIs.

### Asset Transfer in Example Embodiment

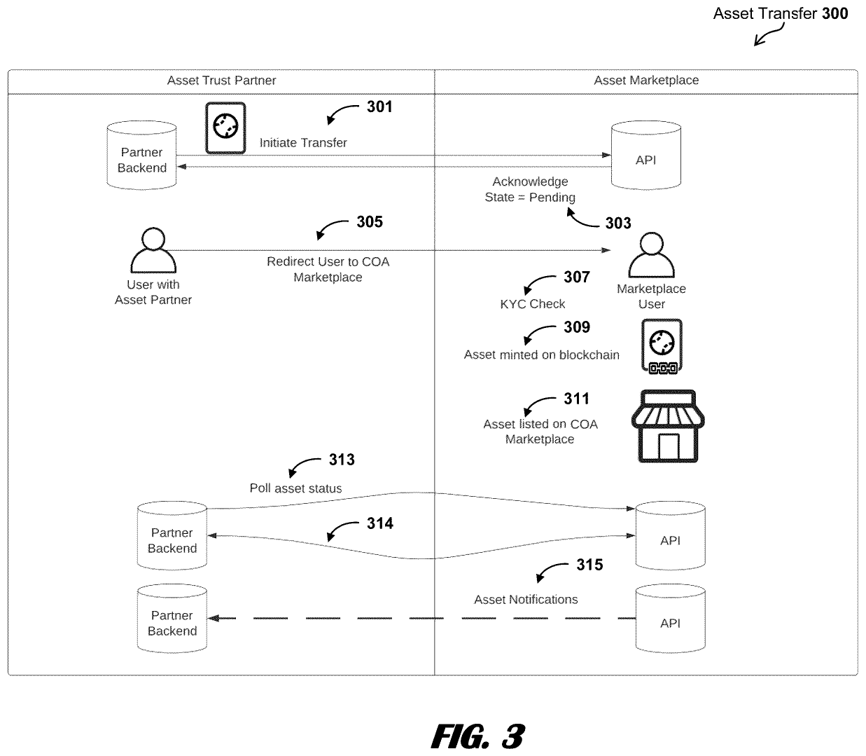

FIG. 3 is a flowchart showing operational steps of a method 300 for minting vault-backed NFTs for a partner company associated with a platform system, according to an embodiment. The method 300 shows the data and operational flow of an API, which may be executed by a platform server, for data or instructions between a platform system and a partner system, which may be operated by a partner entity that collects, sells, or auctions collectibles.

In operation 301, a partner device of the partner system sends an asset transfer request for a live asset to the platform server. The computer may sent the asset transfer request with various types of asset data or asset token data, and in some cases, user data related to the title owner or user requesting the asset transfer.

In some embodiments, the partner system hosts and operates a partner marketplace. The asset transfer request may indicate that the partner devices are no longer listening or hosting the partner marketplace. The platform server executes any number of functions for transferring some or all of the assets, asset tokens, and/or partner marketplace website, into the platform marketplace through various API calls to the API executed by the platform server.

In operation 303, the partner device transfers the live asset and/or asset token, and the APIs of the platform server add the token to a non-transitory temporary storage location. The platform server then transmits an acknowledgement notification indicating that the platform server received the asset transfer request. However, the platform server does not yet list the inbound partner tokens on the platform marketplace.

In operation 305, the platform server or partner marketplace computer redirects a user's asset transaction request from the partner marketplace to the platform server hosting the platform marketplace. In operation 307, the platform server registers the user into the platform database and executes one or more KYC checks. The functions for the KYC checks may include confirming that user's identity and comparing the user profile information against one or more external databases indicating risk-related information.

In operation 309, the platform server executes the smart contract for minting the new asset token, such as the UDA-type title token or COA-type title token. In the example method 300, the smart contract mints the COA-type title token and one or more access tokens associated with the COA-type title token. The platform server updates the platform database and, in some cases, a distributed table in the dApp to include various types of data token data of the title token and access tokens. In operation 311, the platform server updates the marketplace to list the title token and/or the access tokens on the marketplace.

In operation 313, the partner computer executes programming that polls an API of the platform server, where the partner computer may transmit a status request to determine the current status of a given live asset or asset token. In operation 314, the platform server may return the token status data to the partner computer.

Optionally, in operation 315, the platform server may transmit a status notification can send to the partner computer or user device (e.g., webhook notifications, push notification, email). The status notification indicates to the user(s) as the status of pending transactions and alerts the user when any event occurs associated with the particular asset token (e.g., sold, listed, burned, returned to wallet).

### Unchaining Processes

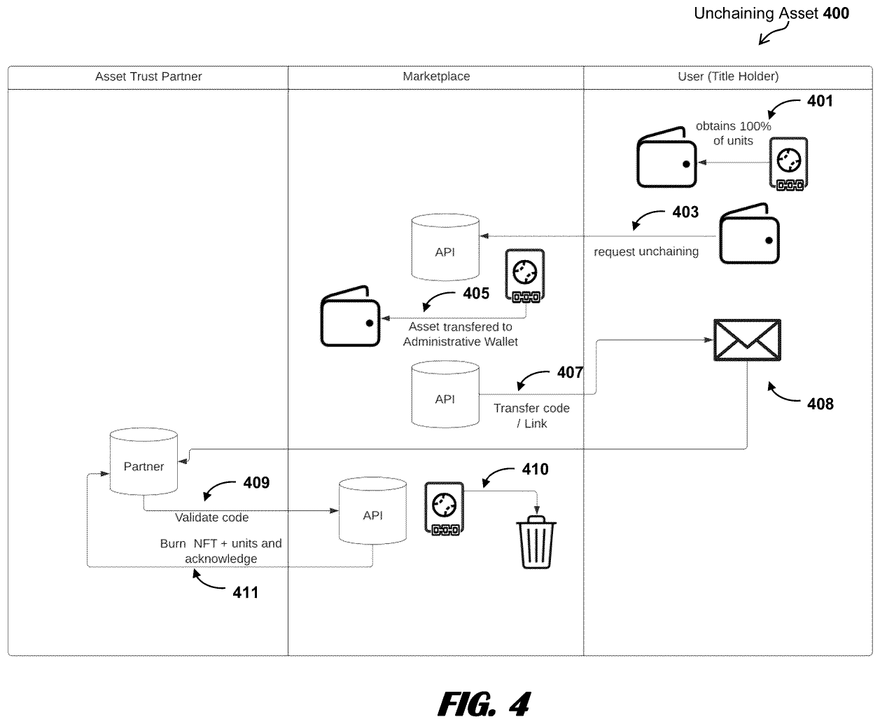

FIG. 4 is a flowchart showing operational steps of a method 400 for redeeming or “unchaining” a live asset represented by a title token and one or more access tokens. The diagram shows flow between a user device of a title user, a platform server hosting a marketplace, and partner computers of a partner system.

In operation 401, the title user holds the title token in the user's wallet. When the title user decides to unchain and repossess the live token, the title user must accrue a quorum threshold number of access tokens for successfully performing the unchaining process. The title user may operate the user's device to perform any number of transactions to accrue the threshold number of access tokens (e.g., 80 or 100 access tokens; 80% or 100% of the access tokens).

In operation 403, when the title user accrues (e.g., repurchases) the threshold number of access tokens, the user may operate the user device to transmit the unchaining request to the platform server. The platform server receives the unchaining request via the API executed by the platform server. The API or other programming of the platform system may confirm whether the title user holds the threshold number of access tokens in the user's wallet. The platform server returns a notification that the unchaining processes fails or is rejected if the platform server determines that the user's wallet does not hold the quorum threshold number of access tokens.

In operation 405, the platform server or other device executes a smart contract for transferring the asset tokens between wallets. The smart contract transfers the title token and access tokens to a central custodial wallet of the platform service.

In operation 407, the platform server or smart contract generates and returns a notification to the user device. The notification contains a link to, for example, a transfer code stored in a platform database or on the blockchain. The transfer code may be, for example, an alphanumeric string or an encoded visual image (e.g. QR code), allowing the user to claim the live asset and/or asset token.

In operation 408, the user device may transmit the transfer code to the partner computer or physically present the transfer code to an employee of the partner. In operation 409, the partner computer transmits the transfer code to the platform server with a validation request. The platform server compares the information received with the validation request against pre-stored expected data associated with the validation request. If the values match, then the platform server validates the transfer code presented by the user.

In operation 410, the platform server or smart contract burns the asset tokens in the custodial wallet of the platform service. For instance, the smart contract transfers the asset tokens to an address of an inaccessible blockchain wallet.

In operation 411, the platform server generates and returns to the partner computer a message including an acknowledgement that the asset tokens were burned (or that a burn request was received from the partner computer). The message may also indicate that the platform server successfully validated the transfer code presented by the user. At this time, the partner provides the live asset to the user, where the partner may turn over possession of a physical asset or may transmit a digital asset to the user device or another online destination for the digital asset.

### Further Example Embodiments

In some embodiments, a computer-implemented method comprises minting, by the computer, a title token on a blockchain to a first blockchain wallet, the title token including a non-fungible token corresponding to a live asset and containing one or more data fields; minting, by the computer, a plurality of access tokens on the blockchain to one or more blockchain wallets, each access token includes a fungible token having a linking data field indicating the title token; and updating, by the computer, a distributed table of a distributed application according to the title token and the plurality of access tokens, the distributed table containing a plurality of table data fields for the title token and each access token, including an address of the first blockchain wallet and the address of each blockchain wallet having at least one access token, and a count of a number access tokens at each blockchain wallet.

In some implementations, the method includes receiving, by the computer, an unchaining request from a user device, the unchaining request indicating a second blockchain wallet having the title token; determining, by the computer, the number of the access tokens at the second blockchain satisfies a threshold amount of access tokens; and transmitting, by the computer, to the user device a notification containing a transfer code for the live asset.

In some implementations, the method includes transferring, by the computer, each access token and the title token to the address of a burning blockchain wallet.

In some implementations, the method includes receiving, by the computer, a redemption request from a user device, the redemption request indicating a requested utility privilege and a second blockchain wallet; determining, by the computer, the one or more data fields of a access token includes the requested utility privilege; and determining, by the computer, the number of the access tokens at the second blockchain satisfies a threshold amount of access tokens.

In some implementations, the computer mints the title token to include a set of utility privileges indicated by the one or more data fields of the title token. The computer mints each access token to include a subset of the utility privileges of the title token indicated by the one or more data fields of the access token.

In some implementations, the computer mints the title token to include a set of utility privileges indicated by the one or more data fields of the title token. The computer mints each access token to include the set of utility privileges of the title token indicated by the one or more data fields of the access token.

In some implementations, the method includes transmitting, by the computer, a notification to the user device indicating the request utility privilege was successfully accessed using the access tokens in the second blockchain wallet.

In some implementations, the method includes receiving, by the computer, an asset token data request from a user device, the asset data request indicating at least one of the title token or the access token; identifying, by the computer, a pointer comprising a uniform resource identifier linking to the asset token data; and retrieving, by the computer, one or more media files in the asset data stored in non-transitory storage indicated by the pointer.

In some implementations, the plurality of data fields of the distributed table includes a uniform resource identifier linking to asset token data for the title token stored at one or more non-transitory storage locations.

In some implementations, the method includes receiving, by the computer, an asset transfer request for minting the title token and the one or more access tokens.

In some implementations, the method includes receiving, by the computer, a transaction order request from a user device, the transaction order request indicating the address of a second blockchain wallet having a access token; updating, by the computer, a webpage to display a status of the transaction order; executing, by the computer, a smart contract for transferring the access token from to the address of second blockchain wallet to the address of a third blockchain wallet; updating, by the computer, the webpage to display an updated status of the transaction order; and updating, by the computer, the distributed table to indicate an updated count of the number access tokens at each blockchain wallet.

In some embodiments, a system comprises a non-transitory machine-readable storage configured to store processor-executed instructions; and a computer comprising a processor coupled to the non-transitory storage. When the processor executes the instructions, the computer is configured to receive an asset transfer request for minting a title token on a blockchain corresponding to a live asset indicated by the asset transfer request; mint the title token on the blockchain to a first blockchain wallet, the title token including a non-fungible token corresponding to the live asset and containing one or more data fields; mint a plurality of access tokens on the blockchain to one or more blockchain wallets, each access token includes a fungible token having a linking data field indicating the title token; and update a distributed table of a distributed application according to the title token and the plurality of access tokens, the distributed table containing a plurality of table data fields for the title token and each access token, including an address of the first blockchain wallet and the address of each blockchain wallet having at least one access token, and a count of a number access tokens at each blockchain wallet.

In some implementations, the computer is further configured to receive an unchaining request from a user device, the unchaining request indicating a second blockchain wallet having the title token; determine the number of the access tokens at the second blockchain satisfies a threshold amount of access tokens; and transmit to the user device a notification containing a transfer code for the live asset.

In some implementations, the computer is further configured to transfer each access token and the title token to the address of a burning blockchain wallet.

In some implementations, the computer is further configured to receive a redemption request from a user device. The redemption request indicates a requested utility privilege and a second blockchain wallet. The computer is further configured to determine the one or more data fields of a access token includes the requested utility privilege; and determine the number of the access tokens at the second blockchain satisfies a threshold amount of access tokens.

In some implementations, the computer mints the title token to include a set of utility privileges indicated by the one or more data fields of the title token. The computer mints each access token to include a subset of the utility privileges of the title token indicated by the one or more data fields of the access token.

In some implementations, the computer mints the title token to include a set of utility privileges indicated by the one or more data fields of the title token. The computer mints each access token to include the set of utility privileges of the title token indicated by the one or more data fields of the access token.

In some implementations, the computer is further configured to receive an asset token data request from a user device, the asset data request indicating at least one of the title token or the access token; identify a pointer comprising a uniform resource identifier linking to the asset token data; and retrieve one or more media files in the asset data stored in non-transitory storage indicated by the pointer.

In some implementations, the plurality of data fields of the distributed table includes a uniform resource identifier linking to asset token data for the title token stored at one or more non-transitory storage locations.

In some implementations, the computer is further configured to receive a transaction order request from a user device, the transaction order request indicating the address of a second blockchain wallet having a access token; update a webpage to display a status of the transaction order; execute a smart contract for transferring the access token from to the address of second blockchain wallet to the address of a third blockchain wallet; update the webpage to display an updated status of the transaction order; and update the distributed table to indicate an updated count of the number access tokens at each blockchain wallet.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method comprising:
minting, by the computer, a title token on a blockchain to a first blockchain wallet, the title token including a non-fungible token corresponding to a live asset and containing one or more data fields;
minting, by the computer, a plurality of access tokens on the blockchain to one or more blockchain wallets, each access token includes a fungible token having a linking data field indicating the title token; and
updating, by the computer, a distributed table of a distributed application according to the title token and the plurality of access tokens, the distributed table containing a plurality of table data fields for the title token and each access token, including an address of the first blockchain wallet and the address of each blockchain wallet having at least one access token, and a count of a number access tokens at each blockchain wallet.

2. The method according to claim 1, further comprising:
receiving, by the computer, an unchaining request from a user device, the unchaining request indicating a second blockchain wallet having the title token;
determining, by the computer, the number of the access tokens at the second blockchain satisfies a threshold amount of access tokens; and
transmitting, by the computer, to the user device a notification containing a transfer code for the live asset.

3. The method according to claim 2, further comprising transferring, by the computer, each access token and the title token to the address of a burning blockchain wallet.

4. The method according to claim 1, further comprising:
receiving, by the computer, a redemption request from a user device, the redemption request indicating a requested utility privilege and a second blockchain wallet;
determining, by the computer, the one or more data fields of a access token includes the requested utility privilege; and
determining, by the computer, the number of the access tokens at the second blockchain satisfies a threshold amount of access tokens.

5. The method according to claim 4, wherein the computer mints the title token to include a set of utility privileges indicated by the one or more data fields of the title token; and
wherein the computer mints each access token to include a subset of the utility privileges of the title token indicated by the one or more data fields of the access token.

6. The method according to claim 4, wherein the computer mints the title token to include a set of utility privileges indicated by the one or more data fields of the title token; and
wherein the computer mints each access token to include the set of utility privileges of the title token indicated by the one or more data fields of the access token.

7. The method according to claim 4, further comprising transmitting, by the computer, a notification to the user device indicating the request utility privilege was successfully accessed using the access tokens in the second blockchain wallet.

8. The method according to claim 1, further comprising:
receiving, by the computer, an asset token data request from a user device, the asset data request indicating at least one of the title token or the access token;
identifying, by the computer, a pointer comprising a uniform resource identifier linking to the asset token data; and
retrieving, by the computer, one or more media files in the asset data stored in non-transitory storage indicated by the pointer.

9. The method according to claim 1, wherein the plurality of data fields of the distributed table includes a uniform resource identifier linking to asset token data for the title token stored at one or more non-transitory storage locations.

10. The method according to claim 1, further comprising receiving, by the computer, an asset transfer request for minting the title token and the one or more access tokens.

11. The method according to claim 1, further comprising:
receiving, by the computer, a transaction order request from a user device, the transaction order request indicating the address of a second blockchain wallet having a access token;
updating, by the computer, a webpage to display a status of the transaction order;
executing, by the computer, a smart contract for transferring the access token from to the address of second blockchain wallet to the address of a third blockchain wallet;
updating, by the computer, the webpage to display an updated status of the transaction order; and
updating, by the computer, the distributed table to indicate an updated count of the number access tokens at each blockchain wallet.

12. A system comprising:
a non-transitory machine-readable storage configured to store processor-executed instructions; and
a computer comprising a processor coupled to the non-transitory storage, when the processor executes the instructions, the computer is configured to:
receive an asset transfer request for minting a title token on a blockchain corresponding to a live asset indicated by the asset transfer request;
mint the title token on the blockchain to a first blockchain wallet, the title token including a non-fungible token corresponding to the live asset and containing one or more data fields;
mint a plurality of access tokens on the blockchain to one or more blockchain wallets, each access token includes a fungible token having a linking data field indicating the title token; and
update a distributed table of a distributed application according to the title token and the plurality of access tokens, the distributed table containing a plurality of table data fields for the title token and each access token, including an address of the first blockchain wallet and the address of each blockchain wallet having at least one access token, and a count of a number access tokens at each blockchain wallet.

13. The system according to claim 12, wherein the computer is further configured to:
receive an unchaining request from a user device, the unchaining request indicating a second blockchain wallet having the title token;
determine the number of the access tokens at the second blockchain satisfies a threshold amount of access tokens; and
transmit to the user device a notification containing a transfer code for the live asset.

14. The system according to claim 13, wherein the computer is further configured to transfer each access token and the title token to the address of a burning blockchain wallet.

15. The system according to claim 12, wherein the computer is further configured to:
receive a redemption request from a user device, the redemption request indicating a requested utility privilege and a second blockchain wallet;
determine the one or more data fields of a access token includes the requested utility privilege; and
determine the number of the access tokens at the second blockchain satisfies a threshold amount of access tokens.

16. The system according to claim 15, wherein the computer mints the title token to include a set of utility privileges indicated by the one or more data fields of the title token; and
wherein the computer mints each access token to include a subset of the utility privileges of the title token indicated by the one or more data fields of the access token.

17. The system according to claim 15, wherein the computer mints the title token to include a set of utility privileges indicated by the one or more data fields of the title token; and
wherein the computer mints each access token to include the set of utility privileges of the title token indicated by the one or more data fields of the access token.

18. The system according to claim 12, wherein the computer is further configured to:
receive an asset token data request from a user device, the asset data request indicating at least one of the title token or the access token;
identify a pointer comprising a uniform resource identifier linking to the asset token data; and
retrieve one or more media files in the asset data stored in non-transitory storage indicated by the pointer.

19. The system according to claim 12, wherein the plurality of data fields of the distributed table includes a uniform resource identifier linking to asset token data for the title token stored at one or more non-transitory storage locations.

20. The system according to claim 12, wherein the computer is further configured to:
receive a transaction order request from a user device, the transaction order request indicating the address of a second blockchain wallet having a access token;
update a webpage to display a status of the transaction order;
execute a smart contract for transferring the access token from to the address of second blockchain wallet to the address of a third blockchain wallet;
update the webpage to display an updated status of the transaction order; and
updating, by the computer, the distributed table to indicate an updated count of the number access tokens at each blockchain wallet.
